(19) United States
(12) Patent Application Publication
(10) Pub. No.: US 2026/0065525 A1
(43) Pub. Date: Mar. 5, 2026

(54) IMAGE PROCESSING

(71) Applicants: Beijing Zitiao Network Technology Co., Ltd., Haidian District, Beijing (CN); Lemon Inc., Grand Cayman (KY)

(72) Inventors: Xin Gu, Beijing (CN); Sijie Zhu, Los Angeles, CA (US); Fan Chen, Los Angeles, CA (US); Longyin Wen, Los Angeles, CA (US)

(21) Appl. No.: 19/304,926

(22) Filed: Aug. 20, 2025

(30) Foreign Application Priority Data
Aug. 30, 2024 (CN) 202411216220.8

(51) Int. Cl. G06T 11/00

(52) U.S. Cl. CPC G06T 11/00

(57) ABSTRACT

A method, apparatus, device, and computer-readable storage medium for image processing are provided. The method includes receiving a text input for an initial image, the text input describing a visual effect for the initial image. A fusion feature for the text input and the initial image is generated based on the text input and the initial image. A target image corresponding to the initial image is generated based on a first image feature of the initial image and the fusion feature, the target image having a visual element related to the visual effect. The fusion of text and image can better express the desired visual effect.

### CROSS REFERENCE

This application claims priority to Chinese Patent Application No. 202411216220.8, filed on Aug. 30, 2024, and entitled “METHOD, APPARATUS, DEVICE, AND STORAGE MEDIUM FOR IMAGE PROCESSING”, the entirety of which is incorporated herein by reference.

### FIELD

Example embodiments of the present disclosure generally relate to the field of computer, and in particular, to image processing.

### BACKGROUND

In the field of computer vision (CV), various image processing techniques based on machine learning have been developed significantly and have wide applications. For example, images with some visual effect (e.g., effect, filter) are desired to be generated and used in many application scenarios such as social, gaming, image edit, and the like. Image processing techniques based on machine learning may be used in such application scenarios to improve user experience. In some example application scenarios, it is desirable to generate an image that matches the user input based on input information of the user, such as text description information.

### SUMMARY

In a first aspect of the present disclosure, there is provided an image processing method. The method comprises: receiving a text input for an initial image, the text input describing a visual effect for the initial image; generating, based on the text input and the initial image, a fusion feature for the text input and the initial image; and generating, based on a first image feature of the initial image and the fusion feature, a target image corresponding to the initial image, the target image having a visual element related to the visual effect.

In a second aspect of the present disclosure, an apparatus for image processing is provided. The apparatus comprises: a receiving module configured to receive a text input for an initial image, the text input describing a visual effect for the initial image; a first generating module configured to generate, based on the text input and the initial image, a fusion feature for the text input and the initial image; and a second generating module configured to generate, based on a first image feature of the initial image and the fusion feature, a target image corresponding to the initial image, the target image having a visual element related to the visual effect.

In a third aspect of the present disclosure, an electronic device is provided. The electronic device comprises at least one processor; and at least one memory, the at least one memory being coupled to the at least one processor and storing instructions for execution by the at least one processor. When executed by the at least one processor, the instructions cause the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that the content described in this content section is not intended to limit the key features or important features of embodiments of the present disclosure, nor is it intended to limit the scope of the present disclosure. Other features of the present disclosure will become easy to understood from the following description.

### BRIEF DESCRIPTION OF DRAWINGS

The above and other features, advantages and aspects of the various embodiments of the present disclosure will become more apparent in combination with the accompanying drawings and with reference to the following detailed description. In the accompanying drawings, the same or similar reference symbols refer to the same or similar elements, wherein:

FIG. 1 illustrates a schematic diagram of an example environment in which embodiments of the present disclosure can be implemented;

FIG. 2 illustrates a schematic diagram of an example architecture of an image processing system according to some embodiments of the present disclosure;

FIG. 3 illustrates a schematic diagram of one example of an initial image according to some embodiments of the present disclosure;

FIG. 4 illustrates a schematic diagram of an example architecture of a multimodal model according to some embodiments of the present disclosure;

FIG. 5 illustrates a schematic diagram of one example of a target image according to some embodiments of the present disclosure;

FIG. 6 illustrates a flowchart of a process of image processing according to some embodiments of the present disclosure;

FIG. 7 illustrates a block diagram of an apparatus for image processing according to some embodiments of the present disclosure; and

FIG. 8 illustrates a block diagram of a device capable of implementing various embodiments of the present disclosure.

### DETAILED DESCRIPTION

It may be understood that, before the technical solutions disclosed in the embodiments of the present disclosure are used, the types, the usage scope, the usage scenario of personal information involved in the present disclosure, and the like should be notified to the user to obtain the authorization of the user in an appropriate manner according to the relevant laws and regulations.

For example, in response to receiving an active request from a user, a prompt message is sent to the user to explicitly prompt the user that the operation requested operation by the user will need to obtain and use the user's personal information, so that users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It may be understood that the above notification and acquisition of user authorization process are only schematic and do not limit the implementations of the present disclosure. Other methods that meet relevant laws and regulations may also be applied to the implementation of the present disclosure.

It may be understood that the data involved in the technical solution (including but not limited to the data itself, the acquisition or use of the data) should follow the requirements of the corresponding laws and regulations and related rules.

Embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the title of any section/subsection provided herein is not limited. Various embodiments are described throughout and any type of embodiments may be included in any section/subsection. Furthermore, embodiments described in any one section/subsection may be combined in any manner with any other embodiments described in the same section/subsection and/or different sections/subsections.

Unless explicitly stated, performing one step “in response to A” does not mean performing the step immediately after “A”, but may include one or more intermediate steps.

In the description of embodiments of the present disclosure, the term “including” and similar terms may be understood as open inclusion, that is, “including but not limited to”. The term “based on” may be understood as “at least partly based on”. The term “one embodiment” or “the embodiment” may be understood as “at least one embodiment”. The term “some embodiments” may be understood as “at least some embodiments”. Other explicit and implicit definitions may also be included below. The terms “first,” “second,” and the like may refer to different or same objects. Other explicit and implicit definitions may also be included below.

As used herein, the term “model” may learn an association between respective input and output from training data such, thereby a corresponding output may be generated for a given input after training is complete. The generation of the model may be based on machine learning techniques. Deep learning is a kind of machine learning algorithm that processes inputs and provides corresponding outputs by using a multi-layer processing unit. “Model” may also be referred to as “machine learning model,” “machine learning network,” or “network” herein, and these terms may be used interchangeably herein. One model may further include different types of processing units or networks.

As used herein, “unit,” “operating unit,” or a “subunit” may be composed of a machine learning model or network of any suitable structure. As used herein, a set of elements or similar expressions may include one or more such elements. For example, “a set of convolution units” may include one or more convolution units.

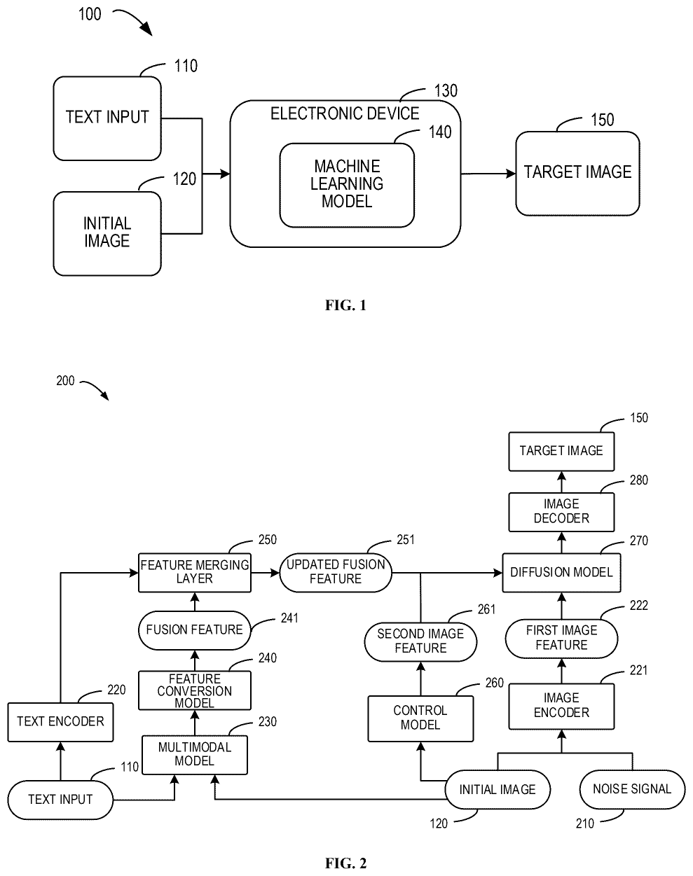

FIG. 1 illustrates a schematic diagram of an example environment 100 in which embodiments of the present disclosure can be implemented. As shown in FIG. 1, the environment 100 may include an electronic device 130.

The electronic device 130 may perform an image edit operation on an initial image 120 according to a text input 110 provided by the user, so as to generate a target image 150 satisfying user requirement. In some embodiments, the initial image 120 may be an image input by the user, or may be an image provided for the user by the electronic device 130. In some embodiments, the initial image 120 may be any one or more frames in the video. The electronic device 130 may adjust image attributes (e.g., contrast, brightness) of the initial image 120 or add, remove, modify image elements, or the like according to user requirement. In some embodiments, in a process of editing the initial image 120, the electronic device 130 first determines an element in the initial image 120 indicated by the text input 110, and then changes the corresponding element in the initial image 120 according to the indication of the text input 110. For example, for the initial image 120 input by the user, if the text input 110 is changing the background of the initial image 120, the background in the initial image 120 is replaced with the background corresponding to the text input 110. If the text input 110 is adding an element in the image, the element that needs to be added is first obtained, and then the element is added to the specified position in the initial image 120.

In some embodiments, the electronic device 130 may utilize the trained machine learning model 140 to perform image processing tasks. For example, the machine learning model 140 may include, but is not limited to, any suitable model such as a Transformer model, a convolutional neural network (CNN), a recurrent neural network (RNN), and a deep neural network (DNN). The machine learning model 140 may be a local model in the electronic device 130, or may be a model installed on other electronic devices 130 (for example, installed in a remote device).

The electronic device 130 may include any computing system having computing capabilities, such as various computing devices/systems, terminal devices, server devices, and the like. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an electronic book device, a gaming device, or any combination of the foregoing, including accessories and peripherals of these devices, or any combination thereof. The server device may be an independent physical server, or may be a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms and the like. The server device may include, for example, a computing system/server, such as a mainframe, an edge computing node, a computing device in a cloud environment, or the like.

It should be understood that the structures and functions of the various elements in the environment 100 are described for example purposes only and do not imply any limitation to the scope of the present disclosure.

As briefly mentioned above, image processing techniques have been applied to various image processing tasks. With the development of image processing techniques, there is a wide demand for image processing tasks in various fields. The user may obtain an image in a content sharing type of application and input the corresponding text to provide an instruction to process the image. For example, changing the hue of the image or replacing any object in the image. Such image may be generated by a terminal device (e.g., a mobile device) installed with a content sharing type of application.

As an example of image edit, most currently used image edit technologies are implemented based on a diffusion model, and a target image corresponding to a user instruction is obtained by processing a text input and an initial image with a codec. However, the target image may not be accurately edited due to more elements in the initial image. For example, if there is a face element in the initial image, the text input indicate to add the sunglasses to the face element in the initial image. Due to the target to be edited may not be accurately determined in the image edit process, the situation of image information in the initial image being lost may be caused.

Embodiments of the present disclosure provide a solution for processing image. According to various embodiments of the present disclosure, a text input for an initial image is received, the text input describing a visual effect for the initial image. A fusion feature for the text input and the initial image is generated based on the text input and the initial image. A target image corresponding to the initial image is generated based on a first image feature of the initial image and the fusion feature, the target image having a visual element related to the visual effect.

In embodiments of the present disclosure, the text input and the initial image are fused, and then the target image matching the text input is generated based on the image feature of the initial image itself and the fusion feature. The desired visual effect can be expressed better with the fused features of text and images. In this way, the accuracy and reliability of image edit can be improved, the loss of information in the initial image can be prevented, and the quality of the generated image can be improved.

FIG. 2 illustrates a schematic diagram of one example of an image processing system 200 according to some embodiments of the present disclosure. As shown in FIG. 2, the image processing system 200 may be included or implemented in the electronic device 130. The image processing system 200 is described below in conjunction with FIG. 1.

In some embodiments, the electronic device 130 may receive the text input 110 for the initial image 120. The text input 110 describes the visual effect for the initial image 120.

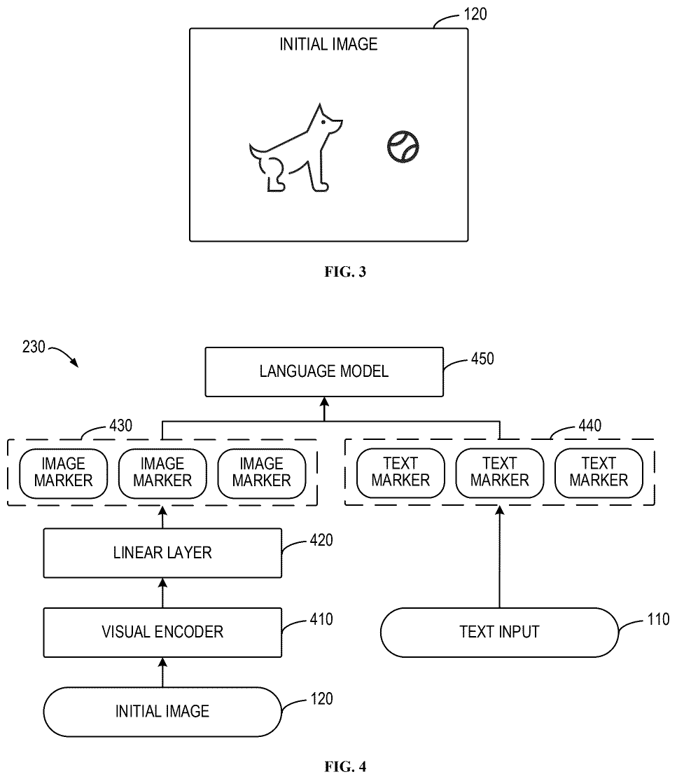

For example, the initial image 120 may be an image provided by a user. The initial image 120 may also be an image provided by the electronic device 130 for the user. For example, in the case of a sharing type of application running in the electronic device 130, the user may select an image posted, shared, or created in the application as the initial image 120. FIG. 3 illustrates a schematic diagram of one example of an initial image 120 according to some embodiments of the present disclosure. As shown in FIG. 3, the initial image 120 includes visual elements such as an object (e.g., a dog, a tennis ball), an image background, and the like.

With the continue reference to FIG. 2. The text input 110 provides the user with an image edit instruction to the electronic device 130. The text input 110 is used to describe the visual effect for the initial image 120. For example, the text input 110 may be one or more objects or image background in the initial image 120, or a size, a color or the like of the initial image 120.

In some embodiments, a user may provide the text input 110 to electronic device 130 in the form of text instructions or speech. For example, the text input 110 may be “replacing the black part in the image background with white”. In some embodiments, a user may provide the text input 110 to the electronic device 130 via an interaction icon provided by electronic device 130. The interaction icon indicates different edit operations for the image, and the different edit operations may include, but is not limited to, an “insert” icon configured to add an element to the image and an “insert element” corresponding to the insertion icon, or a “contrast adjustment” icon configured to change image contrast. For example, if the user triggers an “insert” icon and a corresponding “inserting element A” provided by the electronic device 130, the electronic device 130 generates a text input 110 for “inserting the inserting element A into the original image” in response to the user's operation.

As shown in FIG. 2, the image processing system 200 may generate a fusion feature 241 for the text input 110 and the initial image 120 based on the text input 110 and the initial image 120. For example, the fusion feature 241 may be obtained with a multimodal model 230. The initial image 120 and the text input 110 for the initial image 120 may be provided to the multimodal model 230. The image processing system 200 may use the multimodal model 230 to fuse the initial image 120 and the text input 110 to generate the fusion feature 241.

The multimodal model 230 may be any model with text and image representation capabilities, and may be implemented using any suitable network structure. In some embodiments, the image processing system 200 may provide the text input 110 and the initial image 120 as input to the multimodal model 230 to obtain the output of a predetermined intermediate layer of the multimodal model 230. The image processing system 200 may determine an initial feature 241 based on the output of the predetermined intermediate layer. For example, the predetermined intermediate layer may be the second to the last layer of the multimodal model 230.

FIG. 4 illustrates one example architecture of a multimodal model 230. As shown in FIG. 4, the multimodal model 230 obtains the text input 110 and the initial image 120. Text input 110 is encoded to generate a plurality of text markers 440 (that is, text token). The initial image 120 is processed using the visual encoder 410 to obtain the image feature. The image feature is adjusted with a linear layer 420 to obtain an image marker 430 (that is, text token). Subsequently, the image marker 430 and the text marker 440 are provided to language model 450, thereby obtaining features output by the multimodal model 230. As mentioned above, in some embodiments, the fusion feature 241 may be determined based on an output feature of an intermediate layer (e.g., the second to the last layer) of the language model 450.

In some embodiments, the fusion feature 241 may be determined directly with the multimodal model 230. Such obtained fusion feature 241 may be provided into a subsequent diffusion model 270.

In some embodiments, in order to further ensure that the generated target image satisfies the text input, both the fusion feature and the text feature of the text input may need to participate in the process of generating the target image. In this case, it is necessary to match the feature space of the generated fusion feature with the encoded feature space of the text input, e.g., having the same distribution feature. To this end, in some embodiments, the image processing system 200 may determine an initial feature for fusing the text input 110 and the initial image 120 based on the text input 110 and the initial image 120. The image processing system 200 may then determine the fusion feature 241 by converting the initial feature into an initial feature that has a dimension matching the text encoding.

As shown in FIG. 2, the multimodal model 230 obtains an initial feature by performing fusion of multimodal features on the text input 110 and the initial image 120. The initial feature is then input into a feature conversion model 240. The fusion feature 241 and the input feature space of the diffusion model 270 are matched by utilizing the feature conversion.

Any suitable network structure may be employed to implement the feature conversion model 240. In some embodiments, an attention mechanism may be utilized to convert the initial features output by the multimodal model 230 to determine the fusion feature 241. That is, the feature conversion model 240 may be a model based on the attention mechanism. For example, the feature conversion model 240 may determine a key feature and a value feature for the attention mechanism based on the initial feature. Subsequently, the feature conversion model 240 may determine the fusion feature 241 with the attention mechanism based on the key feature, the value feature, and a predetermined query features. For example, the query feature may be determined in a training process.

Example implementations of text and image fusion branches are described above. At the image branch, the initial image 120 may be encoded or feature extracted to obtain a first image feature 222 of the initial image 120. In some embodiments, as shown in FIG. 2, noise may be introduced in the generation of a first image feature 222. For example, a noise signal 210 and the initial image 120 may be provided to the image encoder 221. The image encoder 221 may generate the first image feature 222 based on the initial image 120 and the noise signal 210.

In some embodiments, the image processing system 200 may generate the target image 150 corresponding to the initial image 120 based on the first image feature 222 of the initial image 120 and the fusion feature 241. The target image 150 has a visual element related to visual effect. The visual element in the target image 150 corresponds to the text input 110.

As mentioned above, in some embodiments, the text feature of the text input and the fusion feature may both participate in the process of generating the target image. In this case, the image processing system 200 may include a branch for text processing. The text feature obtained by the text branch may further be combined or merged with the fusion feature 241. As shown in FIG. 2, the text encoder 220 may generate a text encoding corresponding to the text input 110 based on the text input 110. The fusion features 241 may be updated with the text encoding to obtain an updated fusion feature 251. For example, the fusion feature 241 may be updated by merging the text encoding and fusion feature 241 to obtain the updated fusion feature 251. In addition, the diffusion model 270 may generate the target image 150 based on the updated fusion feature 251 and the first image feature 222 of the initial image 120.

In some embodiments, as shown in FIG. 2, the electronic device 130 may perform a feature merging operation on the text encoding and the fusion feature 241 via the feature merging layer 250 to obtain the updated fusion feature 251. For example, the feature merging layer 250 may perform an adding operation or a concatenation operation on the text encoding and the fusion feature 241. For example, in the case of adding operation, the values of the text encoding and the fusion feature 241 may be directly added according to the dimension of the text encoding and the fusion feature 241. As another example, in the case of a concatenation operation, the text encoding and the fusion feature 241 may be concatenated together in a certain dimension.

The fusion feature 241 or the updated fusion feature 251 may be used by the diffusion model 270 in any suitable way. In some embodiments, the fusion feature 241 or the updated fusion feature 251 may be injected into each layer of the diffusion model 270 through an attention mechanism.

In some embodiments, as much image information as possible in the initial image 120 needs to be input into the diffusion model 270, to prevent the loss of image information that affects the quality of the generated target image 150. Accordingly, the process of generating the target image 150 may be controlled with the initial image 120. As shown in FIG. 2, a second image feature 261 of the initial image 120 may be generated with the control model 260 based on the initial image 120. Subsequently, the diffusion model 270 may generate the target image 150 based on the first image feature 222, the second image feature 261, and the fusion feature 241 (or the updated fusion feature 251). The control model 260 may be constructed using any suitable mechanism or network structure. For example, the control model 260 may be implemented based on a Control Net.

In some embodiments, the diffusion model 270 may generate the target image 150 by using the fusion feature 241 (or the updated fused feature 251) and the second image feature 261 as a control condition. As shown in FIG. 2, an initial image 120 is provided into the image encoder 221 to obtain a first image feature 222 representing the initial image 120. Subsequently, the electronic device 130 provides the first image feature 222 to the diffusion model 270. The diffusion model 270 generates an encoding representation corresponding to the initial image 120 using the second image feature 261 and the fusion feature 241 (or the updated fusion feature 251) as a control condition. The image decoder 280 may perform a decoding operation on the encoding representation generated by the diffusion model 270 to generate a target image 150 corresponding to the text input 110.

An example implementation of the image processing system 200 is described above with reference to FIG. 2. It should be understood that the structure shown in FIG. 2 is merely an example and is not intended to limit the scope of the present disclosure.

One example scenario is described below with continued reference to FIG. 2. The electronic device 130 may generate the target image 150 according to the text input 110 and the initial image 120 input by the user. For example, for the initial image 120 (the image uploaded by the user and/or the image stored in electronic device 130 specified by the user) shown in FIG. 3, the text input 110 input by the user may be “replacing the tennis ball in the figure with the soccer”. The electronic device 130 processes the text input 110 and the initial image 120 with the multimodal model 230 to generate the initial feature for fusing the text input 110 and the initial image 120. Meanwhile, the electronic device 130 performs an encoding operation on the text input 110 with the text encoder 220 to obtain the text encoding. Subsequently, the electronic device 130 concatenates or adds the text encoding and the fusion feature 241 with the feature merging layer 250 to obtain an updated fusion feature 251. The electronic device 130 performs an encoding operation on the initial image 120 and the random noise corresponding to the initial image 120 with the image encoder 221 to obtain a first image feature 222. The first image feature 222, the updated fusion feature 251, and the second image feature 261 generated by the control model 260 are provided to the diffusion model 270 to generate an image encoding.

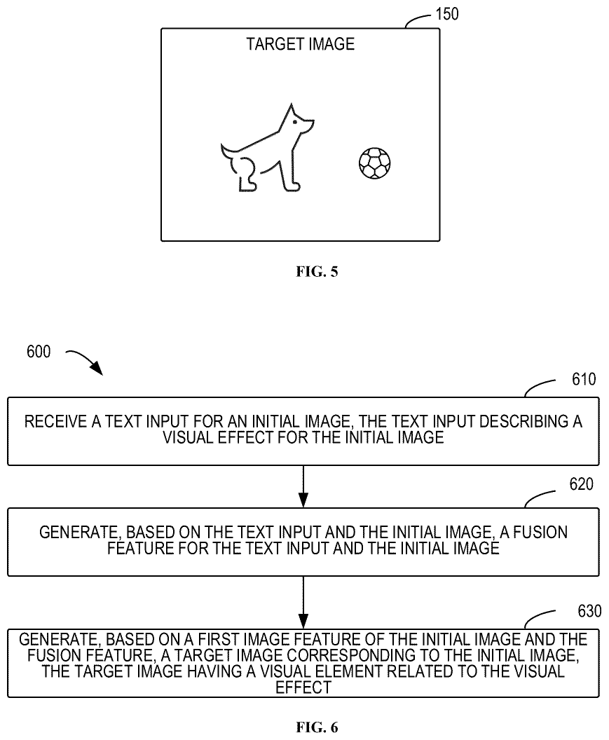

For example, the second image feature 261 and the updated fusion feature 251 may be used as a control condition to generate image encoding based on the first image feature 222 with the diffusion model 270. Subsequently, the target image 150 is generated from the image encoding with the image decoder 280. FIG. 5 illustrates a schematic diagram of an example of a target image 150 according to some embodiments of the present disclosure. As shown in FIG. 5, according to the text input 110 of the user, the electronic device 130 replaces the tennis ball in the initial image 120 with the soccer to generate the target image 150 shown in FIG. 5.

Example embodiments of the image processing system 200 generating the target image are described above. An example embodiment of training the image processing system 200 is described below. To train the image processing system 200, a corresponding training data set may be constructed. As an example, a plurality of initial images may be obtained, for example, obtained from any existing training image set. In addition, an element with some visual effect may be added to the initial image with the rendering effect included in the image rendering tool (e.g., adding a firework effect) or some elements in the initial image are modified to another visual effect (e.g., modifying the color of the flower from red to yellow). Thus, an updated image corresponding to the initial image may be obtained, and a corresponding text description may be generated according to the used rendering effect. In this way, a training sample as following may be obtained, the training sample includes an initial image, a text description, and an updated image as a label or a ground truth.

During the training process, the image processing system 200 may generate a corresponding image based on the initial image and the text description in the training sample. According to on the difference between the generated image and the updated image in the training sample, a loss may be determined, thereby updating parameters of at least a part of the models in the image processing system 200.

It can be seen that, in embodiments of the present disclosure, in one aspect, a target image having a related visual element corresponding to the initial image is generated based on the first image feature of the initial image and the fusion feature for the text input and the initial image. In this way, the elements related to the text input in the initial image can be more accurately expressed by fusing the text and the image, thereby improving the accuracy and reliability of the image edit. In another aspect, the second image feature and the fusion feature generated by the control model are used as the condition control to generate the target image, to prevent the loss of information in the initial image, thereby further improving the quality of the edited target image. In a further aspect, the initial image and the random noise signal are input into the image encoder, so that the diversity of the input image is improved, and the quality of the target image is improved.

FIG. 6 illustrates a flowchart of a process of image processing according to some embodiments of the present disclosure. Process 600 may be implemented at an electronic device.

At block 610, a text input for an initial image is received, the text input describing a visual effect for the initial image.

At block 620, a fusion feature for the text input and the initial image are generated based on the text input and the initial image.

In some embodiments, generating the fusion feature for the text input and the initial image comprises: determining, based on the text input and the initial image, an initial feature for fusing the text input and the initial image; and determining the fusion feature by converting the initial feature into an initial feature that has a dimension matching the text encoding.

At block 630, a target image corresponding to the initial image is generated based on a first image feature of the initial image and the fusion feature, the target image having a visual element related to the visual effect.

In some embodiments, determining the fusion feature by converting the initial feature into the initial feature that has the dimension matching the text encoding comprises: determining, based on the initial feature, a key feature and a value feature for an attention mechanism; and determining, based on the key feature, the value feature, and a predetermined query feature, the fusion feature with the attention mechanism.

In some embodiments, the first image feature of the initial image is determined by: generating, based on the initial image and a noise signal, the first image feature with an image encoder.

In some embodiments, generating the target image corresponding to the initial image comprises: generating, based on the initial image, a second image feature of the initial image with a control model; and generating the target image based on the first image feature, the second image feature, and the fusion feature.

In some embodiments, generating the target image based on the first image feature, the second image feature, and the fusion feature comprises: generating, based on the first image feature, the target image by using the second image feature and the fusion feature as a control condition.

In some embodiments, the process 600 further includes, before generating the target image based on the first image feature and the fusion feature, generating, based on the text input, a text encoding corresponding to the text input with a text encoder; and updating the fusion feature with the text encoding.

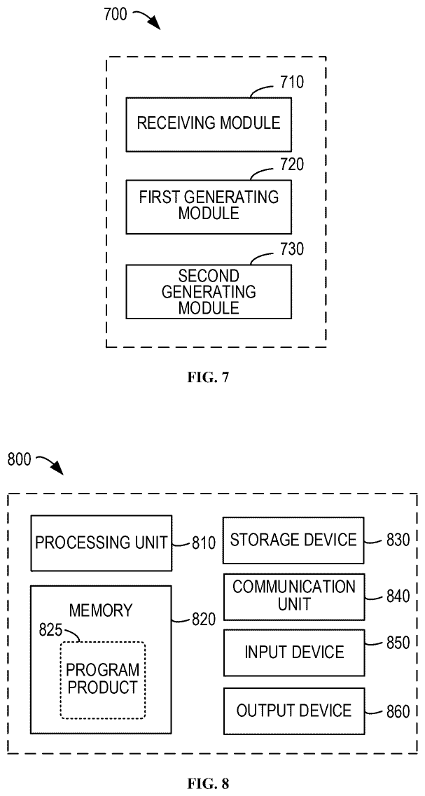

FIG. 7 illustrates a block diagram of an apparatus for image processing according to some embodiments of the present disclosure. The apparatus 700 may be implemented or included in an electronic device. The various modules/components in the apparatus 700 may be implemented by hardware, software, firmware, or any combination thereof.

As shown in the figure, the apparatus 700 includes a receiving module 710 configured to receive a text input for an initial image, the text input describing a visual effect for the initial image. The apparatus 700 further includes a first generating module 720 configured to generate, based on the text input and the initial image, a fusion feature for the text input and the initial image. The apparatus 700 further includes a second generating module 730 configured to generate, based on a first image feature of the initial image and the fusion feature, a target image corresponding to the initial image, the target image having a visual element related to the visual effect.

In some embodiments, the second generating module 730 is further configured to generate, based on the text input, a text encoding corresponding to the text input with a text encoder; obtain an updated fusion feature by performing a feature fusion operation on the text encoding and the fusion feature; and generate a target image based on the updated fusion feature and the initial image.

In some embodiments, the second generating module 730 is further configured to determine, based on the initial feature, a key feature and a value feature for an attention mechanism; and determine, based on the key feature, the value feature, and a predetermined query feature, the fusion feature with the attention mechanism.

In some embodiments, the second generating module 730 is further configured to generate, based on the initial image and a noise signal, the first image feature with an image encoder.

In some embodiments, the second generation module 730 is further configured to generate, based on the initial image, a second image feature of the initial image with a control model; and generate the target image based on the first image feature, the second image feature, and the fusion feature.

In some embodiments, the second generating module 730 is further configured to generate, based on the first image feature, the target image by using the second image feature and the fusion feature as a control condition.

In some embodiments, the apparatus 700 further includes an updating module configured to before generating the target image based on the first image feature and the fusion feature, generate, based on the text input, a text encoding corresponding to the text input with a text encoder; and update the fusion feature with the text encoding.

FIG. 8 illustrates a block diagram illustrating an electronic device 800 in which one or more embodiments of the present disclosure may be implemented. It should be understood that the electronic device 800 illustrated in FIG. 8 is only an example and should not constitute any limitation on the functionality and scope of the embodiments described herein. The electronic device 800 shown in FIG. 8 may be configured to implement the electronic device 110 in FIG. 1.

As shown in FIG. 8, the electronic device 800 is in the form of a general electronic device. The components of the electronic device 800 may include, but are not limited to, one or more processors or processing units 810, a memory 820, a storage device 830, one or more communication units 840, one or more input devices 850, and one or more output devices 860. The processing units 810 may be an actual or virtual processors and can execute various processes according to the programs stored in the memory 820. In a multiprocessor system, multiple processing units execute computer executable instructions in parallel to improve the parallel processing capability of the electronic device 800.

The electronic device 800 typically includes a plurality of computer storage media. Such media can be any available media that is accessible to the electronic device 800, including but not limited to volatile and non-volatile media, removable and non-removable media. The memory 820 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 830 can be any removable or non-removable medium, and can include machine-readable medium, such as a flash drive, a disk, or any other medium which can be used to store information and/or data and can be accessed within the electronic device 800.

The electronic device 800 may further include additional removable/non-removable, volatile/non-volatile storage medium. Although not shown in FIG. 8, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 820 can include a computer program product 825, which comprises one or more program modules, and these program modules are configured to execute various methods or actions of the various embodiments of the present disclosure.

The communication unit 840 implements communication with other electronic devices via a communication medium. In addition, functions of components in the electronic device 800 may be implemented by a single computing cluster or multiple computing machines, and these computing machines can communicate through a communication connection. Therefore, the electronic device 800 may be operated in a networking environment using a logical connection with one or more other servers, a network personal computer (PC), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required. The external device, such as a storage device, a display device, etc., communicate with one or more devices that enable users to interact with the electronic device 800, or communicate with any device (for example, a network card, a modem, etc.) that enables the electronic device 800 communicate with one or more other electronic devices. Such communication may be executed via an input/output (I/O) interface (not shown).

According to example implements of the present disclosure, there is provided a computer-readable storage medium having computer-executable instructions stored thereon, wherein the computer-executable instructions are executed by a processor to implement the method described above. According to example implements of the present disclosure, a computer program product is further provided, the computer program product being tangibly stored on a non-transitory computer-readable medium and including computer-executable instructions, and the computer-executable instructions are executed by a processor to implement the method described above.

Various aspects of the present disclosure are described herein with reference to flowcharts and/or block diagrams of the method, the device, the apparatus and the computer program product implemented in accordance with the present disclosure. It should be understood that each block of the flowchart and/or the block diagram, and the combinations of each blocks in the flowcharts and/or block diagrams may be implemented by computer readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Various implementations of the present disclosure has been described above. The above description is example, not exhaustive, and is not limited to the disclosed implementations. Without departing from the scope and spirit of the described implementations, many modifications and changes are obvious to ordinary skilled in the art. The selection of terms used in this article aims to best explain the principles, practical application or improvement of technology in the market of each implementation, or to enable other ordinary skilled in the art to understand the various embodiments disclosed herein.

What is claimed is:

1. An image processing method, comprising:
receiving a text input for an initial image, the text input describing a visual effect for the initial image;
generating, based on the text input and the initial image, a fusion feature for the text input and the initial image; and
generating, based on a first image feature of the initial image and the fusion feature, a target image corresponding to the initial image, the target image having a visual element related to the visual effect.

2. The method of claim 1, further comprising:
before generating the target image based on the first image feature and the fusion feature,
generating, based on the text input, a text encoding corresponding to the text input with a text encoder; and
updating the fusion feature with the text encoding.

3. The method of claim 1, wherein generating the fusion feature for the text input and the initial image comprises:
determining, based on the text input and the initial image, an initial feature for fusing the text input and the initial image; and
determining the fusion feature by converting the initial feature into an initial feature that has a dimension matching the text encoding.

4. The method of claim 3, wherein determining the fusion feature by converting the initial feature into the initial feature that has the dimension matching the text encoding comprises:
determining, based on the initial feature, a key feature and a value feature for an attention mechanism; and
determining, based on the key feature, the value feature, and a predetermined query feature, the fusion feature with the attention mechanism.

5. The method of claim 3, wherein determining the initial feature for fusing the text input and the initial image comprises:
providing the text input and the initial image as input to a multimodal model to obtain an output of a predetermined intermediate layer of the multimodal model; and
determining the initial feature based on the output of the predetermined intermediate layer.

6. The method of claim 1, wherein generating the target image corresponding to the initial image comprises:
generating, based on the initial image, a second image feature of the initial image with a control model; and
generating the target image based on the first image feature, the second image feature, and the fusion feature.

7. The method of claim 6, wherein generating the target image based on the first image feature, the second image feature, and the fusion feature comprises:
generating, based on the first image feature, the target image by using the second image feature and the fusion feature as a control condition.

8. The method of claim 1, wherein the first image feature of the initial image is determined by:
generating, based on the initial image and a noise signal, the first image feature with an image encoder.

9. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
receiving a text input for an initial image, the text input describing a visual effect for the initial image;
generating, based on the text input and the initial image, a fusion feature for the text input and the initial image; and
generating, based on a first image feature of the initial image and the fusion feature, a target image corresponding to the initial image, the target image having a visual element related to the visual effect.

10. The electronic device of claim 9, wherein the acts further comprise:
before generating the target image based on the first image feature and the fusion feature,
generating, based on the text input, a text encoding corresponding to the text input with a text encoder; and
updating the fusion feature with the text encoding.

11. The electronic device of claim 9, wherein generating the fusion feature for the text input and the initial image comprises:
determining, based on the text input and the initial image, an initial feature for fusing the text input and the initial image; and
determining the fusion feature by converting the initial feature into an initial feature that has a dimension matching the text encoding.

12. The electronic device of claim 11, wherein determining the fusion feature by converting the initial feature into the initial feature that has the dimension matching the text encoding comprises:
determining, based on the initial feature, a key feature and a value feature for an attention mechanism; and
determining, based on the key feature, the value feature, and a predetermined query feature, the fusion feature with the attention mechanism.

13. The electronic device of claim 11, wherein determining the initial feature for fusing the text input and the initial image comprises:
providing the text input and the initial image as input to a multimodal model to obtain an output of a predetermined intermediate layer of the multimodal model; and
determining the initial feature based on the output of the predetermined intermediate layer.

14. The electronic device of claim 9, wherein generating the target image corresponding to the initial image comprises:
generating, based on the initial image, a second image feature of the initial image with a control model; and
generating the target image based on the first image feature, the second image feature, and the fusion feature.

15. The electronic device of claim 14, wherein generating the target image based on the first image feature, the second image feature, and the fusion feature comprises:
generating, based on the first image feature, the target image by using the second image feature and the fusion feature as a control condition.

16. The electronic device of claim 9, wherein the first image feature of the initial image is determined by:
generating, based on the initial image and a noise signal, the first image feature with an image encoder.

17. A non-transitory computer-readable storage medium having a computer program stored thereon, the computer program being executable by a processor to perform acts comprising:
receiving a text input for an initial image, the text input describing a visual effect for the initial image;
generating, based on the text input and the initial image, a fusion feature for the text input and the initial image; and
generating, based on a first image feature of the initial image and the fusion feature, a target image corresponding to the initial image, the target image having a visual element related to the visual effect.

18. The non-transitory computer-readable storage medium of claim 17, wherein the acts further comprise:
before generating the target image based on the first image feature and the fusion feature,
generating, based on the text input, a text encoding corresponding to the text input with a text encoder; and
updating the fusion feature with the text encoding.

19. The non-transitory computer-readable storage medium of claim 17, wherein generating the fusion feature for the text input and the initial image comprises:
determining, based on the text input and the initial image, an initial feature for fusing the text input and the initial image; and
determining the fusion feature by converting the initial feature into an initial feature that has a dimension matching the text encoding.

20. The non-transitory computer-readable storage medium of claim 19, wherein determining the fusion feature by converting the initial feature into the initial feature that has the dimension matching the text encoding comprises:
determining, based on the initial feature, a key feature and a value feature for an attention mechanism; and
determining, based on the key feature, the value feature, and a predetermined query feature, the fusion feature with the attention mechanism.
